(19) United States
(12) Patent Application Publication
(10) Pub. No.: US 2014/0123169 A1
(43) Pub. Date: May 1, 2014

(54) SIMULCASTING CONDITIONAL ACCESS CHANNEL SERVICE OFFERINGS FOR VIDEO DELIVERY IN A TELECOMMUNICATIONS NETWORK

(71) Applicant: ADARA TECHNOLOGIES INC., Mississauga (CA)

(72) Inventors: Stanislav Koukarine, North York, CA (US); Joseph D. Nucara, Oakville (CA)

(73) Assignee: Adara Technologies Inc., Mississauga (CA)

(21) Appl. No.: 13/661,867

(22) Filed: Oct. 26, 2012

(51) Int. Cl. H04N 21/2347

(52) U.S. Cl. 725/31

(57) ABSTRACT

A telecommunications system utilizes switched video technologies to deploy video programming over a second conditional access system (CAS) in parallel with video programming broadcast over an incumbent CAS. The programming content is switched onto the second CAS only when requested by a subscriber, thus the content deployed over the second CAS occupies a fraction of the transport channels the first CAS occupies. A full channel lineup can be simulcast using a fraction of the traditional CAS bandwidth. This arrangement permits subscriber set top boxes to be configured for either the traditional CAS protocol or the second CAS protocol. In one embodiment, the second CAS programming content is simulcast in parallel with the traditional programming content using spare transport channels in the existing RF spectrum. Thus, the cable television operator can incorporate the SDV technology and second CAS without replacement of or disruption to the traditional CAS equipment.

### FIELD OF THE INVENTION

This disclosure relates generally to a radio frequency telecommunications system for distributing video content to a subscriber and, more specifically, to a system that simulcasts video content encrypted with a first conditional access system to incumbent end terminals, and video content encrypted with a second conditional access system to switched video end terminals in the same access layer distribution network.

### BACKGROUND OF THE INVENTION

Digital cable TV video solutions have been dominated by two prominent companies since the late 1990's. The two vendors each use their own proprietary conditional access systems (CAS) to enable their respective service provider customers to encrypt video content and deliver it in encrypted format to set-top boxes located in subscriber homes. Equipped with their respective proprietary CAS decryption mechanisms, each vendor's set-top boxes are able to decrypt the video signals based upon the conditional access defined by the service provider for that subscriber's paid subscription and display the video on a TV/video screen. Due to the proprietary nature of the CAS and the significant investment required, service providers have been, essentially, locked to a one-vendor solution.

In recent years, several additional solution vendors have emerged, each offering competing methods to accomplish not only the secure transmission and distribution of digital format video, but also the incremental ability to deliver more services like high definition into an already crowded radio frequency (RF) network spectrum, and the ability to migrate toward the more modern delivery and distribution of video via Internet Protocol (IP). Unfortunately, each vendor maintains their own proprietary CAS and associated set-top box decryption.

One of the problems, then, is that a cable television service provider locked into vendor A's CAS but wanting to partner with a new digital cable solution vendor would need to consider the cost and customer disruption of a full “fork-lift” replacement of vendor A's proprietary headend equipment and corresponding set-top boxes containing the proprietary decryption keys. Often, the high capital expenditure and service disruption render the decision moot.

Another noted problem in the cable television industry is the shrinking availability of bandwidth in radio frequency spectrum. The bandwidth available to cable operators is defined by a frequency range divided into a discrete number of transport channels. Current technology permits only a limited number program channels on each transport channel. To compound the problem, a single high definition program occupies approximately the same bandwidth as four or five standard definition programs. Thus, using current technology, a cable television operator cannot provide the same number of program channels in high definition as subscribers received in standard definition.

### SUMMARY OF THE INVENTION

Embodiments of the present invention utilize switched digital video (SDV) technology to deploy video programming over a second conditional access system in parallel with video programming deployed over the incumbent conditional access system. Because the programming content is switched onto the second CAS only when requested by a subscriber, the content deployed over the second CAS occupies a fraction of the transport channels the first CAS occupies. Thus, a full channel lineup can be simulcast using a fraction of the traditional CAS bandwidth. This arrangement permits subscriber set top boxes to be configured for either the traditional conditional access protocol (e.g., vendor A) or the second conditional access protocol (e.g., vendor B). In one embodiment, the second CAS programming content is simulcast in parallel with the traditional programming content using spare transport channels in the existing RF spectrum. Thus, the cable television operator can incorporate the SDV technology and second CAS without replacement of or disruption to the traditional CAS equipment.

In other embodiments of the invention, the second conditional access system can include Internet Protocol Television (IPTV) content deployed over a DOCSIS system. The content can be switched and aggregated onto spare transport channels in the existing RF spectrum and delivered to subscriber set top boxes in much the same manner.

In accordance with one aspect of the disclosure, a telecommunications system is provided to simulcast video content over a radio frequency spectrum to a customer network of end terminals. The system includes a broadcast content source providing program input streams, and a first encryptor coupled to the broadcast content source. The first encryptor is adapted to encrypt at least a portion of a first channel service offering according to a first conditional access protocol. The telecommunications system further includes a second encryptor coupled to the broadcast content source. The second encryptor is adapted to encrypt at least a portion of a second channel service offering according to a second conditional access protocol. The second channel service offering includes the first channel service offering plus additional video content. The telecommunications system further includes a network switch adapted to route, upon a request from an end terminal, a portion of the second channel service offering to the end terminal. The end terminal is adapted to decrypt the portion of the second channel service offering. The telecommunications system further includes an access layer network combiner device adapted to combine the first channel service offering and the second channel service offering onto a single combined channel service offering for simulcast to the customer network, thereby permitting the customer network end terminals to decrypt as desired from the first conditional access protocol or the second conditional access protocol.

In another aspect of the disclosure, a method is provided for simulcasting video content to a customer network of end terminals. The method includes a step of aggregating a program input stream from a broadcast content source onto a first channel service offering and a second channel service offering. The first channel service offering includes a first channel lineup, the second channel service offering includes a second channel lineup, and the second channel lineup includes at least the first channel lineup. The method further includes a step of encrypting at least a portion of the first channel service offering with a first encryptor. The first encryptor is adapted to encrypt a video content stream according to a first conditional access protocol. The method further includes the steps of selecting, by one or more of the end terminals, a program channel from the second channel lineup, and switching a program stream including the selected program channel onto the second channel service offering. The method further includes a step of encrypting the second channel service offering with a second encryptor. The second encryptor is adapted to encrypt a video content stream according to a second conditional access protocol. The method further includes a step of combining the first channel service offering and the second channel service offering onto a combined channel service offering for simulcast to the customer network of end terminals.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a schematic diagram of a telecommunications system;

FIG. 2 depicts a schematic diagram of a spectrum of RF transport channels in a traditional telecommunications system;

FIG. 3 depicts a block diagram of an exemplary end terminal in the telecommunications system of FIG. 1;

FIG. 4 depicts a high-level block diagram of a telecommunications system according to one embodiment of the present invention;

FIG. 5 depicts a schematic diagram of a telecommunications system according to one embodiment of the present invention;

FIG. 6 depicts a schematic diagram of a telecommunications system according to another embodiment of the present invention; and

FIG. 7 depicts a schematic diagram of a spectrum of RF transport channels in a telecommunications system according to one embodiment of the present invention.

### DETAILED DESCRIPTION OF THE INVENTION

As used herein, the term “application” refers generally to a unit of executable software that implements a certain functionality.

As used herein, the term “headend” refers generally to a networked system controlled by an operator (e.g., a multiple systems operator or MSO) that distributes programming to MSO clientele using client devices. The term “MSO” refers to a cable, fiber to the home (FTTH), fiber to the curb (FTTC), satellite, or terrestrial network provider having infrastructure required to deliver services including programming and data over those mediums.

As used herein, the term “service,” “content,” “program,” and “stream” are sometimes used synonymously to refer to a sequence of packetized data that is provided in what a subscriber may perceive as a service. A “service” (or “content”, or “stream”) in the former, specialized sense may correspond to different types of services in the latter, non-technical sense. For example, a “service” in the specialized sense may correspond to, among others, video broadcast, audio-only broadcast, pay-per-view, or video-on-demand. The perceivable content provided on such a “service” may be live, pre-recorded, delimited in time, undelimited in time, or of other descriptions. In some cases, a “service” in the specialized sense may correspond to what a subscriber would perceive as a “channel” or “program channel” in traditional broadcast television.

As used herein, the term “service group” refers to either a group of service users (e.g., subscribers/end terminals) or the resources shared by them.

As used herein, the terms “channel” and “program channel” are all generally synonymous with the concept of a perceived stream of information, as distinguished from a “transport channel,” which is used to physically carry and distribute the content, which may for example comprise one or more RF EIA channels within a given portion of the RF spectrum of a cable system.

As used herein, “channel lineup” refers to the program channel choices offered to subscribers.

As used herein, the term “simulcast” refers to the parallel transmission of two or more content streams over an RF spectrum, wherein at least a portion of each content stream is encrypted by different encryption protocols.

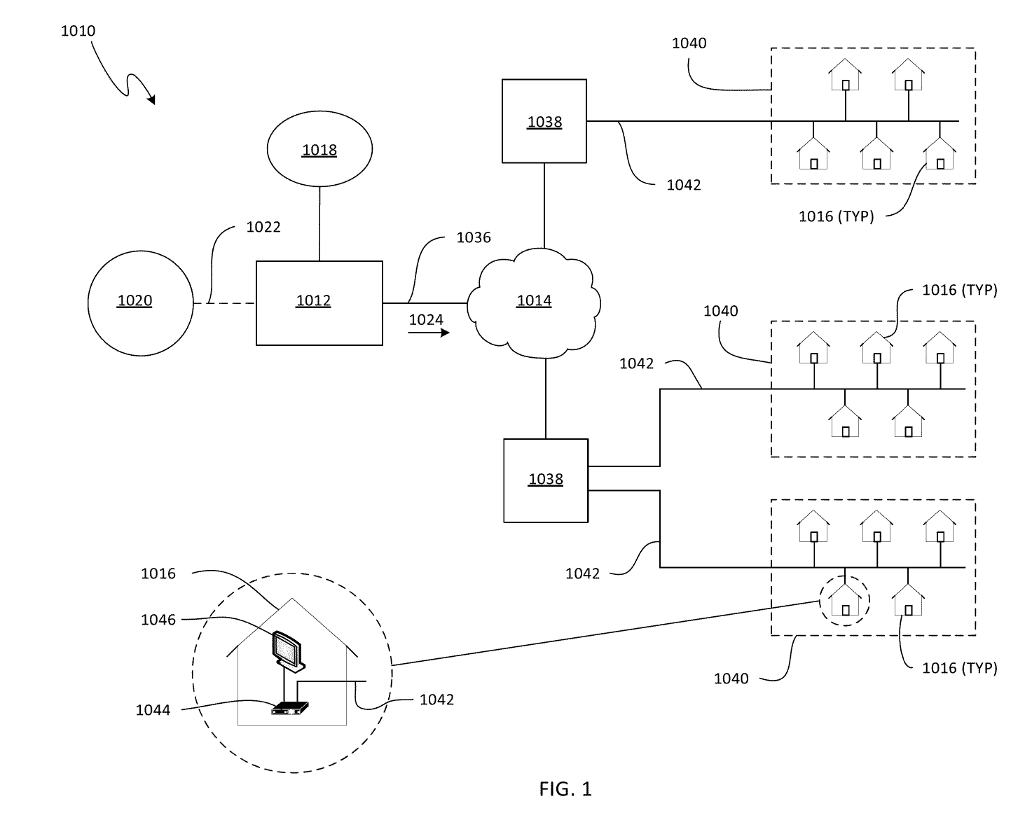

Referring to FIG. 1, shown is a high-level architecture of an exemplary broadband telecommunications system 1010 which may utilize various embodiments of the present invention. The telecommunications system 1010 includes a master facility, or headend 1012, for receiving television signals or other content for processing and distribution over a cable television system, or RF access network 1014. The RF access network 1014, or customer network, is typically arranged into a tree and branch structure to provide the cable content to individual subscriber locations 1016.

The telecommunications system 1010 further includes a service infrastructure 1018, a logical grouping of components and subsystems that provide analog and digital services and control the operation of the network. The service infrastructure 1018 may be physically located within the headend 1012, or dispersed among the headend, hubs, and other system operator facilities. Generally, the service infrastructure 1018 can include value-added service providers, a network control system (NCS), an administrative gateway (AG), a network management system (NMS), and a core network, which interconnects other service infrastructure components with the headend.

The value-added service providers originate all broadcast services within the telecommunications system 1010, and provide delivery of broadcast services to the headend for distribution to the subscriber locations 1016. The service infrastructure 1018 may include multiple value-added service providers, each providing a unique set of services. Value-added service provider systems may include the traditional analog sources and distribution systems as well as digital servers and digital satellite and terrestrial broadcast distribution systems. Accordingly, the telecommunications system 1010 includes a variety of broadcast content sources 1020 delivering a plurality of program input streams 1022 controlled by a cable or multiple systems operator (MSO). The broadcast content sources 1020 may include transport mechanisms such as via satellite or through terrestrial packet data networks, for example. The program input streams 1022 may be encoded in various ways and may exhibit variable bit rates. Furthermore, each program input stream 1022 may be an aggregate stream carrying multiple programs within a single data stream. The program input streams 1022 may comprise video program content, and may include analog broadcasts, standard-definition television (SDTV) streams, and high-definition television (HDTV) streams, which may include ultra high definition streams, three-dimensional television (3DTV) streams, and other as yet to be conceived video streams. The streams 1022 are most often compressed or uncompressed digital signals, but may also include analog signals that are to be converted to digital form for transport.

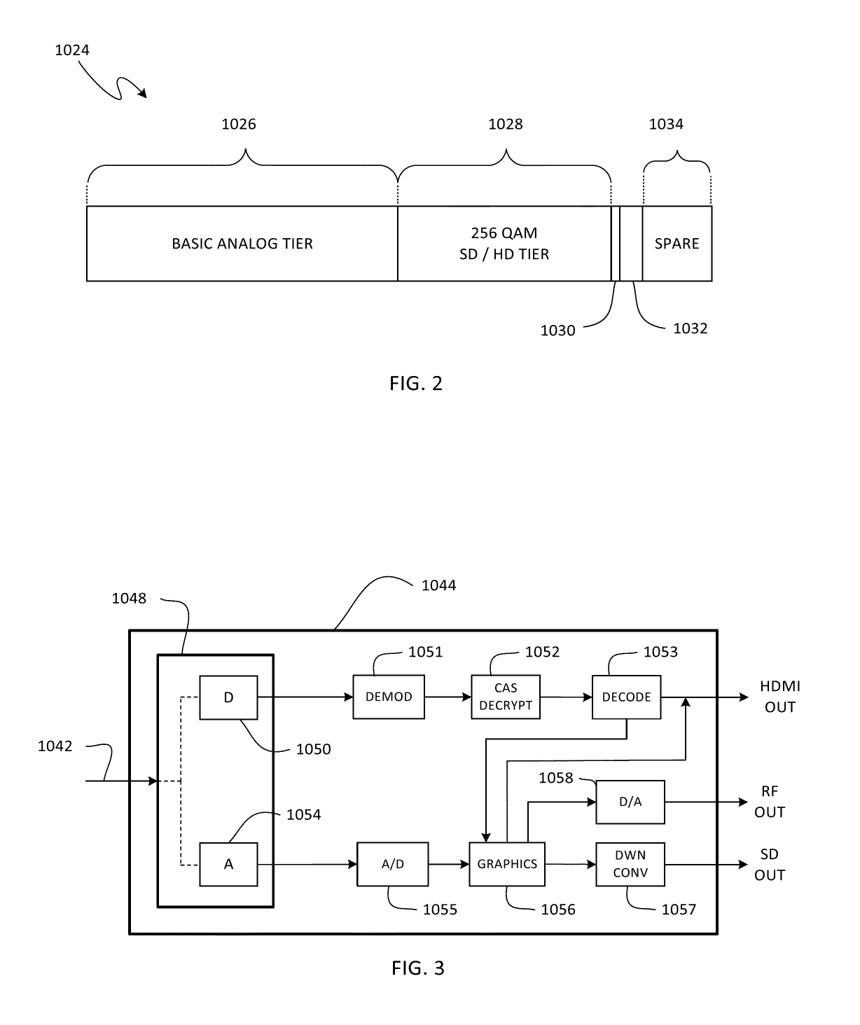

The telecommunications system 1010 includes equipment and applications at the headend 1012 or regional hub to terminate the program input streams 1022, selectively aggregate and then switch the program content onto a spectrum of RF transport channels on the network 1014 to reach end terminals in each subscriber's home or business 1016. FIG. 2 depicts a schematic diagram of an exemplary spectrum 1024 of RF transport channels. Each transport channel is typically 6-8 MHz wide (6 MHz in United States, 8 MHz in Europe, for example). The spectrum 1024 may also include an analog tier 1026 comprising 40 to 90 transport channels. One analog program channel may be transmitted on each transport channel of the analog tier 1026. The spectrum 1024 further includes an SD/HD tier 1028 comprising digital program channels formatted in standard definition (SD) and high definition (HD). The SD/HD tier 1028 may comprise 40 to 50 transport channels, with each channel capable of carrying approximately 7-12 SD program channels (in MPEG2 format), 2-3 HD program channels in MPEG2 format, or some combination of both. The spectrum 1024 may further include a small block of digital telephone transport channels 1030 for carrying voice over Internet protocol (VoIP) transmissions, for example. The spectrum 1024 may further include a block of channels 1032 reserved for Internet traffic. The number of transport channels assigned to each tier 1026, 1028 or block 1030, 1032 depends on the particular needs of the cable operator. In any event, there typically exist a number of spare transport channels 1034 that the cable operator uses for value-added services such as video on demand (VoD). As noted, a single value-added program channel broadcast in HD (such as a VoD broadcast) will occupy approximately half of the bandwidth of a spare transport channel. The aggregation of all the 6-MHz transport channels carrying video content in the spectrum 1024 (e.g., 1026, 1028, 1034) is the entire video line-up offered by the cable provider. The entire video line-up can also include video content carried by the Internet tier 1032 of the spectrum.

Returning to FIG. 1, transmission network 1036 which distributes the program content in spectrum 1024 from the headend 1012 to the access network 1014 may include electrical cables or an optical fiber telecommunications system. The access network 1014 may be a hybrid fiber-coaxial (HFC) network using a combination of fiber and coaxial cables for communication between the headend 1012 and the subscribers 1016. In the illustrated example, a fiber-optic transmission system is used between the headend 1012 and a fiber-node 1038 that is located near a group of homes or businesses, or service group 1040. A coaxial cable transmission system 1042 arranged as a tree and branch structure provides connectivity between the fiber-node 1038 and the subscribers 1016. A single fiber path can support multiple fiber-nodes 1038, and each fiber-node 1038 can support multiple service groups 1040. Also (and more typically), multiple nodes can be part of a single service group. The total number of subscribers 1016 that can be supported by a single fiber path thus depends on a variety of factors such as the number of connected fiber-nodes 1038 and the interactive usage (e.g., bandwidth) per connected subscriber. The particular structure of the access network 1014 is not important to the scope of the invention, and embodiments included herein are exemplary. For example, other embodiments of access network 1014 could include fiber to the home (FTTH), such as radio frequency over glass (RFoG), or fiber to the TV.

The RF access network 1014, and in particular the coaxial cable 1042, carries the programming content to one or more end terminals 1044 within each subscribing home or business 1016. In general, the term “end terminal” includes, but is not limited to, set top boxes (STBs), cable modems, digital video recorders, personal computers, and minicomputers, whether desktop, laptop, or otherwise, mobile devices such as handheld computers, PDAs, personal media devices, and smartphones, video gateway terminals, certain digital televisions, multimedia/gaming consoles, embedded multimedia terminal adapters (eMTA), a combination cable modem and telephone adapter, or an integrated access device (IAD) that provides access to wide area networks and the Internet. The set top box, which is an integrated receiver/decoder, demultiplexes the incoming program content and delivers it via program channels to a display 1046, for example.

FIG. 3 depicts a high-level block diagram of an exemplary end terminal 1044, such as a set top box, according to one embodiment of the present invention. The coaxial cable transmission system 1042 (e.g., coaxial cable) is connected to an RF receiver stage having a tuner 1048. The tuner 1048 includes two circuit paths, namely a digital path and an analog path. The digital path includes a digital tuner 1050 which sends the HD and SD content to a demodulator 1051, such as a 256 QAM demodulator. The demodulator 1051 outputs a MPEG-2 or MPEG-4 encoded video stream that passes to a conditional access decrypter 1052 for decryption according to the particular conditional access protocol being employed. The conditional access decrypter 1052 may be a multi-stream CableCard™ device, for example, or a downloadable conditional access system (DCAS) that performs decryption operations on the selected program(s). The output of the conditional access decrypter 1052 is then fed to a decoder 1053 which outputs a high-definition multimedia interface (HDMI) format, for example.

The analog path includes an analog tuner 1054 which sends the analog signals to an analog-to-digital (A/D) converter 1055 for conversion to digital frames in the same format as the output of the decoder 1053. The output of the A/D converter 1055 and optionally the output of the decoder 1053 pass to a graphics module 1056 to add graphics to the frames, such as the manner in which the channel guide is displayed, or the manner in which Video On Demand graphics are displayed, for example. The uncompressed high definition video output of the graphics module 1056 can be output to HDMI or may pass to a down-converter 1057 for down-conversion to standard definition (SD) format, for example composite S-video. The analog video passes to a digital-to-analog (D/A) converter 1058 for conversion back to analog output (RF).

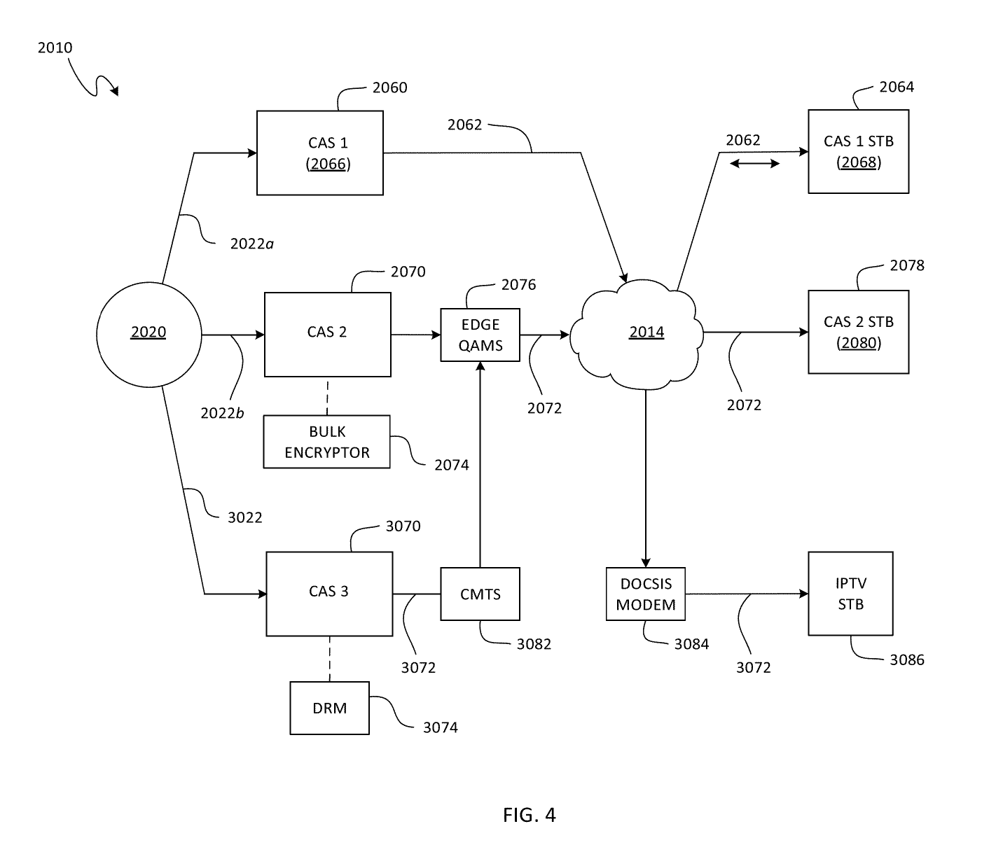

FIG. 4 depicts a high-level block diagram of a telecommunications system 2010 according to one embodiment of the present invention Like numerals indicate like elements from FIG. 1. The system 2010 includes a broadcast content source 2020 providing program input streams 2022a, 2022b, 3022 which may include analog broadcasts, standard-definition television (SDTV) streams, high-definition television (HDTV) streams, ultra high definition streams, and three-dimensional television (3DTV) streams, for example. The telecommunications system 2010 includes a first conditional access system (CAS 1) 2060 coupled to the broadcast content source 2020 providing first program input streams 2022a that comprise an incumbent or legacy conditional access protocol, such as that utilized by cable operators. The first conditional access system 2060 provides a first channel service offering 2062 over an access network 2014, as described with reference to FIG. 1, to incumbent end terminals 2064 in the cable operator's service group. The first conditional access system 2060 includes a first encryptor 2066 adapted to encrypt at least a portion of the first channel service offering 2062 according to the incumbent conditional access protocol. The incumbent end terminals 2064 are likewise provisioned with an incumbent decrypter 2068 to decrypt the first channel service offering 2062.

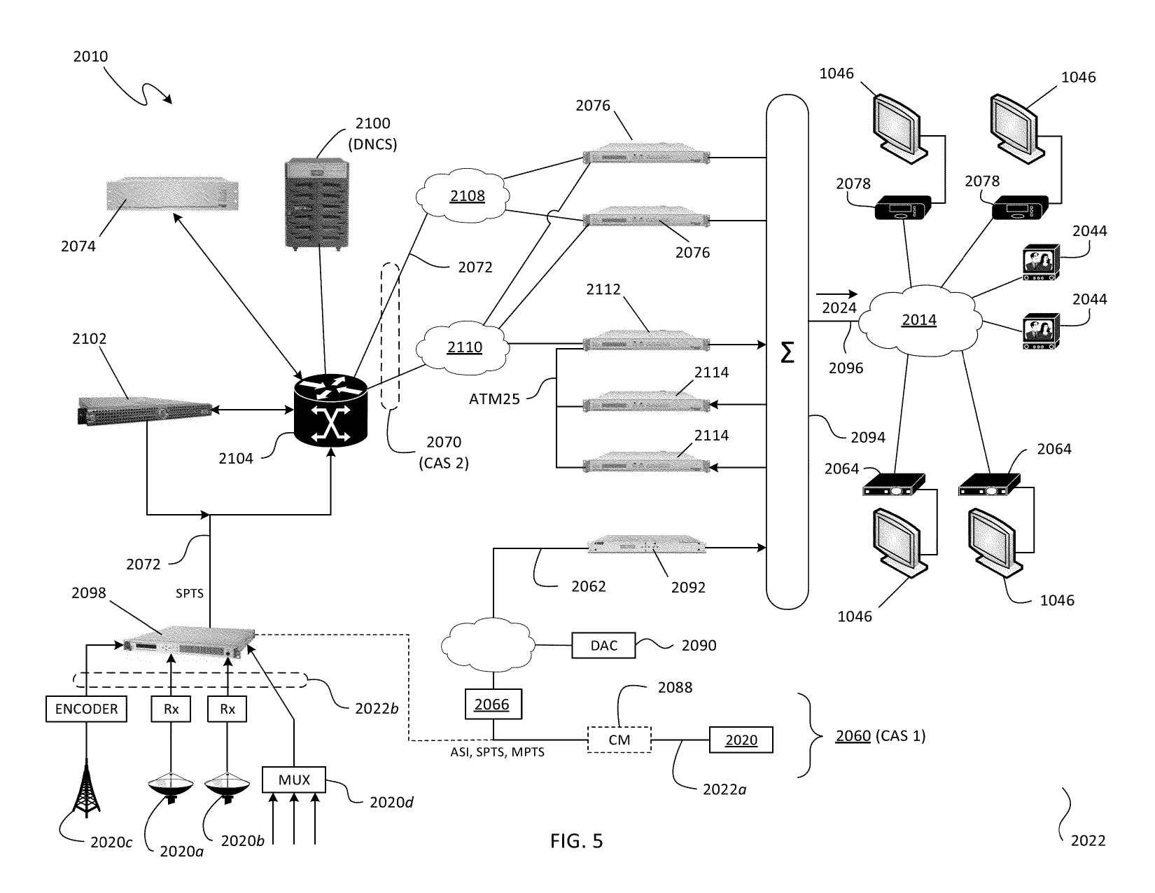

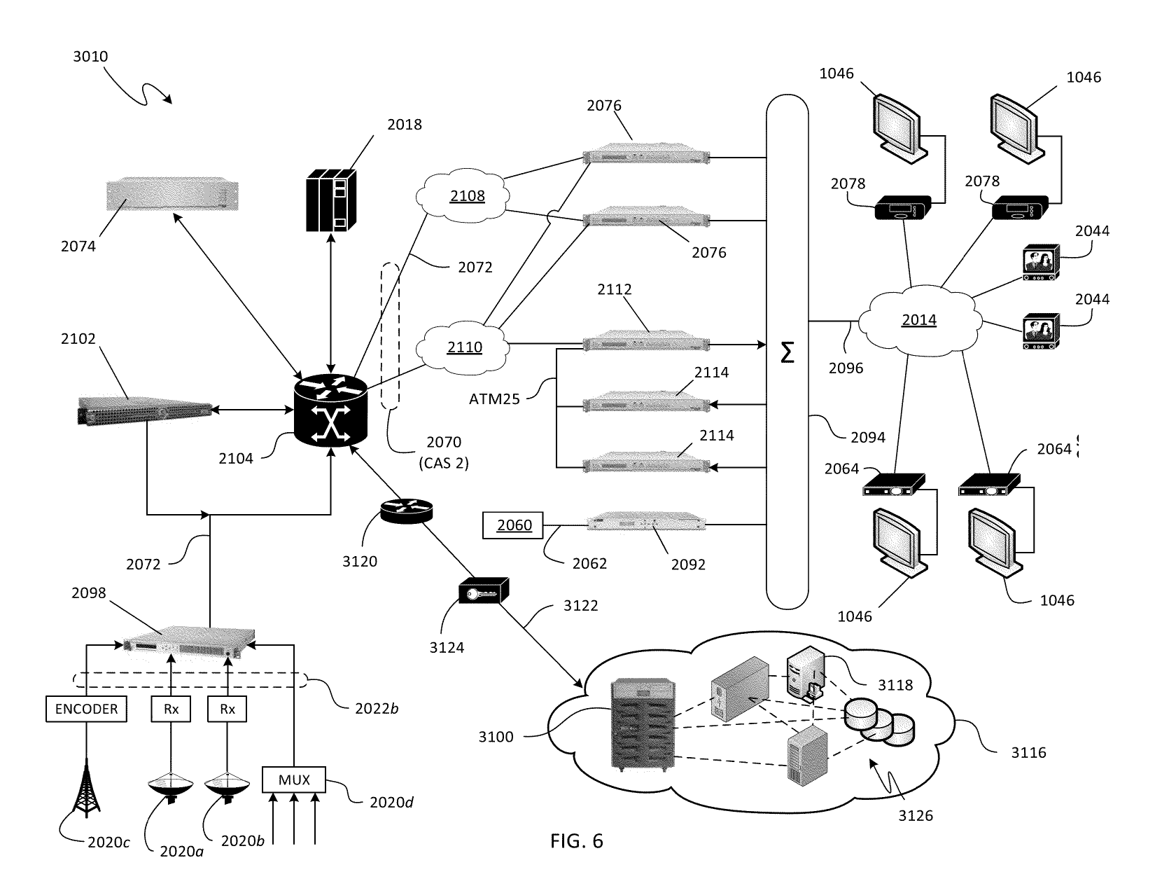

The telecommunications system 2010 further includes a second conditional access system (CAS 2) 2070 coupled to the broadcast content source 2020 providing second program input streams 2022b to deliver a second channel service offering 2072 over the access network 2014. In one embodiment, the second conditional access system 2070 is a switched digital system. The second conditional access system 2070 includes a second encryptor 2074 adapted to encrypt at least a portion of the second channel service offering 2072 according to a second conditional access protocol. As will be explained in more detail with reference to FIGS. 5 and 6, an edge modulation device 2076 modulates the second channel service offering 2072 onto the access network 2014 for delivery to second CAS end terminals 2078. The second CAS end terminals 2078 are provisioned with a second CAS decrypter 2080 to decrypt the second channel service offering 2072.

In another embodiment of the invention, the telecommunications system 2010 may include a third conditional access system (CAS 3) 3070 coupled to the broadcast content source 2020 providing third program input streams 3022 comprising switched IPTV over DOCSIS. The switched IPTV conditional access system 3070 may operate in conjunction with the CAS 2 conditional access system 2070, independent of the CAS 2 conditional access system 2070, or the CAS 2 conditional access system 2070 may not be present in the telecommunications system 2010. IPTV literally means Internet Protocol Television, but generally refers to multimedia services such as television, video, audio, text, graphics, or data delivered over IP-based networks. Internet Protocol television is a system through which television services are delivered using the Internet protocol suite over a packet-switched network such as the Internet or a local service provider network, instead of being delivered through traditional terrestrial, satellite signal, and cable television formats. The DOCSIS (Data Over Cable Service Interface Specification) standard permits cable TV operators to use their hybrid fiber-coaxial (HFC) networks to deliver broadband data services. A typical system includes a cable modem termination system (CMTS) located at the headend, and a cable modems in each subscriber location, both of which are connected to the HFC network. Program content from the Internet, such as IPTV, is passed through the CMTS, then passed to an edge modulation device for modulation onto the combined channel service offering, in the same manner as the SDV stream.

Encrypting for IPTV over DOCSIS can be provided by a Digital Rights Management (DRM) module 3074, which is a class of access control technologies that are used by hardware manufacturers, publishers, copyright holders and individuals with the intent to limit the use of digital content and devices. In one example, the CableCard standard may be used for DRM 3074. The CableCard standard is used by cable television providers in the United States to restrict content to services to which the customer has subscribed.

Program content 3072 from the Internet, such as IPTV, is sourced from the third program input stream 3022 and terminated at a cable modem termination system (CMTS) 3082, then passed to the edge modulation device 2076 to be modulated onto the access network 2014 for delivery to a modem 3084 coupled to an IPTV end terminal 3086.

Referring now to FIG. 5, wherein like numerals indicate like elements in FIGS. 1-4, one embodiment of the broadband telecommunications system 2010 depicted in FIG. 4 is shown in greater detail. The system 2010 includes switched digital video (SDV) equipment and applications to allow simulcasting a greater selection of programming content than that offered through traditional content delivery approaches.

The telecommunications system 2010 may receive program input streams 2022a from multiple broadcast content sources 2020, such as digital satellite 2020a, 2020b, over-the-air 2020c, and terrestrial 2020d broadcast distribution systems. The content 2022a can include analog or digital sources. Digital sources can include standard and high definition video comprising MPEG streams (e.g., MPEG-2, MPEG-4, etc.). Transport protocols can include Asynchronous Serial Interface (ASI) streaming data format, or Gigabit Ethernet Internet Protocol (GigE IP), for example. In some networks, the multiple broadcast content sources 2020 can include over 1,000 program input streams.

The telecommunications system 2010 includes a first conditional access system 2060, labeled as CAS 1, which in the illustrated example is an incumbent conditional access system, such as that utilized by cable operators, utilizing the incumbent's CA protocol. The first conditional access system 2060 provides a first channel service offering 2062 over an access network 2014 to incumbent end terminals 2064 in the cable operator's service group. The first conditional access system 2060 includes a first encryptor 2066 adapted to encrypt at least a portion of the first channel service offering 2062 according to the incumbent conditional access protocol. The incumbent end terminals 2064 are likewise provisioned with an incumbent decrypter 2068 (not shown) to decrypt the first channel service offering 2062.

The first conditional access system 2060 may optionally include an incumbent content manager 2088. The incumbent content manager 2088 constructs MPEG-2 (or MPEG-4) transport streams for delivering digital video services to the subscriber locations 2014. The content manager 2088 is a re-multiplexor and transport stream processor that receives the program input streams 2022a and aggregates them into the first channel service offering 2062. The content manager 2088 terminates the input signals received from the broadcast content sources 2020 and reconstructs them as input stream packets and IP datagrams. The packets may include audio, video, and data. The content manager 2088 can filter the rebuilt channel service offering packets by packet identifier (PID), and insert packets with selected PIDs into the first channel service offering 2062. Thus, the content manager 2088 can extract the individual program streams from aggregate streams that it receives and then selectively recomposes or “re-multiplexes” new, aggregate first channel service offerings 2062 from a number of single program streams. The content manager 2088 can also be used as a source of digital interactive services such as pay-per-view or promotional channels. The content manager 2088 can also perform rate control so as not to exceed the bandwidth limitations of the digital transmission channels or the forward data channels.

An incumbent network control system 2090 provides for the management, monitoring, and control of network elements and broadcast services provided to subscriber locations, including management and control of incumbent end terminals 2064. Typical functions of the network control system 2090 include processing and managing digital broadcast service definitions, assigning network 2010 resources for transporting digital broadcast services, communicating system information to the subscribers, and informing the conditional access system of the security requirements of digital video services. Requests for resources come to the network control system 2090 from the broadcast content sources 2020 via session resource manager (not shown). Upon receipt of a resource request, the network control system 2090 will allocate the appropriate network resources and store this allocation within its database system. The network control system 2090 controls the channel service offerings 2062 through a network router or network switch (shown as cloud). In one example, the incumbent network control system 2090 includes a digital addressable control (DAC) server.

In the illustrated example, the content manager 2088 is shown generally having one output. However, the incumbent content manager 2088 may output in multiple formats, such as Gigabit Ethernet (GigE) or ASI format. ASI format typically carries multi-program transport streams, but could also carry single program transport streams, and GigE format typically carries single program transport streams (SPTS), and/or multi-program transport streams (MPTS). The output of the incumbent content manager 2088, or at least the program input streams 2022a, pass to a first encryptor 2066 to have encryption applied according to the incumbent conditional access protocol. The encrypted first channel service offering 2062 then passes to a first modulator 2092. As used herein, a “modulator” refers to a device or application that modulates information onto a signal, including (but not limited to) quadrature amplitude modulation (e.g., 64 point or 256 point QAM), phase shift keying (e.g., PSK or QPSK), vestigial sideband modulation (e.g., 16-VSB), frequency modulation (FM), and pulse-code modulation (PCM). The first modulator 2092 is shown in schematic form only. In one example, the first modulator 2092 could include a plurality of QAMs to process the ASI, SPTS, and MPTS.

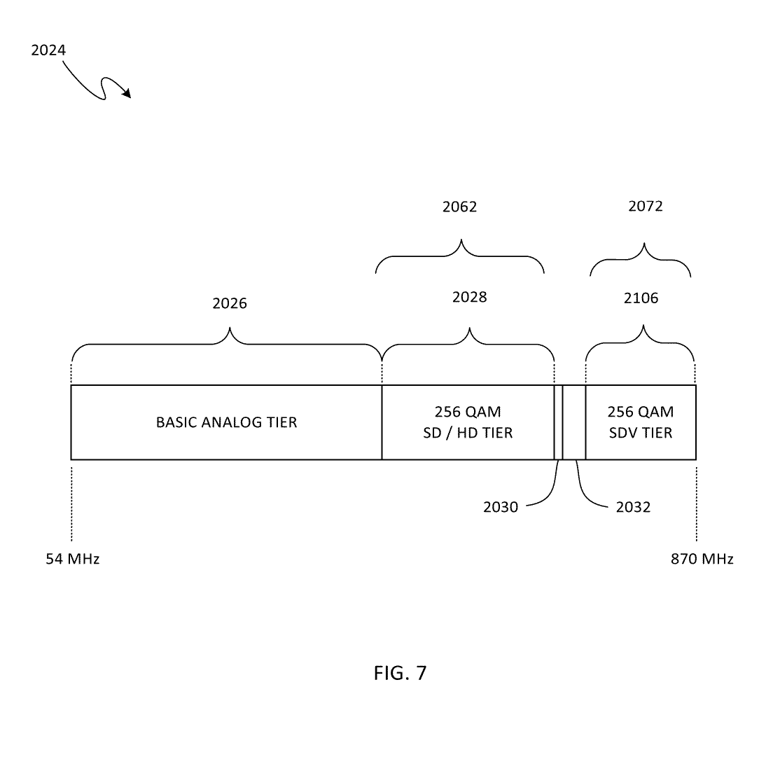

In one embodiment, the first modulator 2092 is a 256-QAM modulator that receives the first channel service offering 2062 and modulates the content onto an RF spectrum 2024 of 6 MHz-wide transport channels. An exemplary RF spectrum 2024 is depicted in FIG. 7, and includes transport channels in an RF range between 54 MHz and 870 MHz (e.g., 136 transport channels). In one example, the 256-QAM modulator 2092 modulates content from the first channel service offering 2062 onto the SD/HD tier 2028. As noted above, the exact number of 6 MHz transport channels assigned to the 256-QAM SDTV/HDTV broadcast tier varies among cable operators, a typical range is 40-50 slots (and 40-90 slots for analog programming). A 6 MHz slot can be used to deliver 1 analog broadcast channel, or, using 256 QAM and MPEG-2 format, 7-12 standard definition (SD) digital broadcast channels, or 2-3 high definition (HD) digital broadcast channels. Any combination of the content can be multiplexed onto each slot.

As noted, the first channel service offering 2062 can be transmitted according to the MPEG-2 standard. In order for the set top box to locate and decode a program on channel service offering 2062, the MPEG-2 standard defines four sets of information that can be sent in the channel service offering: a program allocation table (PAT); a program map table (PMT); and a private data section including a conditional access table (CAT). For each program carried in the channel service offering, the program allocation table designates the packet identifier (PID) of the packets carrying its PMT. The program map table (PMT) identifies the video, audio, and private data streams by PID number that together form each program. The conditional access table designates the PID of the packets carrying the entitlement management message (EMM) used to decode an encrypted conditional access program. The private data stream may include an entitlement control message (ECM), as discussed below.

The first channel service offering 2062 may undergo encryption through a first encryptor 2066. This is commonly done in support of conditional access (CA), that is, encrypting program streams to control which subscriber locations 2016 (FIG. 1) are able to view a given program. As illustrated, the first encryptor 2066 forms a part of the first channel service offering 2062. However, the first encryptor 2066 could also be integrated within the content manager 2088, if present. As used herein, the term “encryption” refers to any access control scheme, whether implemented in hardware, software, or firmware (or combinations thereof), including but not limited to members of the Cisco PowerKEY family, Videoguard, mVideoGuard, ANSI/SCTE Standard 52 2003 (DVS-042), and “DigiCipher” family (DigiCipher 2, etc.). These encryption schemes can be implemented using, for example, the so-called “CableCard” plug-in security module access technology, a downloadable CA system (DCAS), or otherwise.

Typically, access to conditional access content is available through a monthly subscription to the cable operator or by pay-per-view. Implementation of conditional viewing is carried out by encrypting the program's elementary streams with a 16-bit control word, for example. The control word needed by the set top box to decode the program channel is encrypted with a service key and transmitted within an entitlement control message (ECM) on a packet identifier that is specified in the program map table (PMT). The service key used to encrypt the control word is itself encrypted with a user key that is also contained within the conditional access decrypter of the set top box and transmitted inside an entitlement management message (EMM) on a PID specified in the conditional access table. Each user key is unique and is held within the conditional access decrypter that is paired with a set top box. A subscriber management system (SMS) maintains a record of set top box and conditional access decrypter pairs and their association to a subscriber and the programs they pay for. The SMS configures the conditional access system, which generates ECM and EMM streams to create EMMs for Smartcards whose subscriber's have paid for access.

After being modulated onto a spectrum of RF transport channels by the first modulator 2092, the first channel service offering 2062 enters an access layer network combiner device 2094 which combines multiple input signals and combines them to a combined channel service offering 2096. The single RF output stream 2096 can be distributed to the nodes, service groups, or subscriber locations via the RF access network 2014 which, in the illustrated embodiment, is an HFC network.

End terminals such as set top boxes provide an interface to the access network 2014 and support the reception of analog and digital services. The end terminals typically receive and display a channel lineup of the program channel choices offered to subscribers.

When a particular program channel is selected by a subscriber, the tuner 1048 (FIG. 3) selects the corresponding program stream from the appropriate transport channel. For analog services, the STB tunes to the selected analog transport channel of the combined channel service offering 2096, extracts the signal, and outputs the signal to the television, DVD player, DVR, or other home electronics device. For digital services, the STB tunes to the appropriate digital transport channel of the combined channel service offering 2096, demodulates the QAM signal, extracts the MPEG-2 (or MPEG-4) channel service offering packets and decrypts them (if applicable), decompresses the video and audio streams, and generates an output signal which is carried to a display 1046.

In a conventional or incumbent set top box, the entire programming content offered by the MSO or cable company occupies the vast majority of transport channels in the RF spectrum. That is, the entire analog and digital programming content is transported up to the set top box at the subscriber location, essentially waiting for the STB tuner to select one of the channels. In one example, only 8-12 transport channels are open (e.g., unoccupied) in the RF spectrum. This is especially inefficient because most households are typically tuned to no more than one, two, or three program channels at a time. Except for the 8-12 open channels and the 1-3 live channels, the remaining transport channels in the RF spectrum are occupied, but dormant.

Although such an arrangement can be useful and may be advantageous for certain applications, it suffers from drawbacks. One drawback is that the cable operator or MSO is constrained by a finite number of available transport channels or slots, a finite bandwidth within each slot, and a finite amount of digital content that can be multiplexed onto each slot (e.g., two or three HD channels in MPEG-2 format). As the market demand for HD channels grows, the cable operator may be forced to eliminate some channels in the analog and SD lineup to make room for the HD content. Furthermore, the cable operator must allocate free channels or slots in the RF spectrum for popular value-added services such as video-on-demand (VoD), data services, voice over IP (VoIP) services, targeted advertising, and video mosaics, for example. As the market demand for HD content grows, the cable operator can quickly run out of available bandwidth.

One solution to this dilemma offered by large-scale MSOs utilizes switched digital video (SDV) for long tail programming (e.g., television programs or channels that are used on an infrequent basis). In this implementation, seldom-used program channels are removed from the SDTV/HDTV channel service offering, thereby freeing up slots. The freed-up slots can then be filled with more popular or HD programming, for example. The long tail channels are made available by a switched digital video architecture. Switched digital video is a dynamic multicast mechanism implemented over a broadcast network. When a subscriber selects one of the long tail channels, the STB sends a request to a SDV session manager at the headend. The headend equipment retrieves the channel content from the broadcast content source, performs encoding and encryption, then transmits the channel content to the subscriber's STB using a block of reserved or “edge” transport channels. Channel service offerings along the edge channels, which may include VoD for example, are typically multiplexed on a “best effort” basis by an edge QAM device, described below. In effect, the long tail SDV implementation removes from the first channel service offering those channels that are seldom viewed, and replaces them with new channels that are more popular. The seldom-used channels are made available to the subscriber by a second, SDV channel service offering on an “on-demand” basis (although the subscriber is unaware of the difference).

One drawback to this approach is that implementing SDV architecture to provide the second, SDV channel service offering can require expensive upgrades to the headend equipment, and requires specialized talent to maintain and operate. Therefore, implementing an SDV architecture has historically been cost-prohibitive to all but the largest MSOs.

A second drawback to this approach is that older or incumbent set top boxes furnished to the subscribers by the MSO are not easily made SDV-capable. A subscriber with an incumbent STB may therefore be unable to receive the long tail programming, even though the channels are displayed in the program guide. This problem would initially be rampant because virtually all MSOs furnish identical set top boxes to their subscribers that are the same brand and offer similar commonality, such as uniform conditional access encryption. MSOs commonly purchase multiple models of STBs from a single manufacturer so the MSO only needs to encrypt the content streams using a single method. Every STB in the network will be capable of decoding the encryption. This presents an economical solution to encrypting and decrypting, but the MSO will be unable to implement switched digital video if their chosen STB manufacturer does not produce a system including a set top box that economically supports SDV content. The MSO is thus faced with the undesirable and cost-prohibitive choice of a full “fork lift” replacement of the proprietary headend equipment and all the set top boxes containing the proprietary decryption keys.

The inventors of the present invention have devised a system and method of operation that alleviate the aforesaid drawbacks. According to one embodiment of the invention, a switched digital video architecture enables MSOs to simultaneously transmit (a) a first channel service offering comprising the traditional content programming described above, along with (b) a second, SDV channel service offering comprising subscriber-selectable content that includes all of the program channel choices in the first stream plus additional program channel choices. In this manner, subscribers with incumbent set top boxes are able to view the traditional program lineup (including long tail programming) via the first channel service offering, and subscribers with an upgraded set top box are able to view everything available on the first channel service offering plus additional content via the second, SDV channel service offering.

In one possible embodiment of such a network architecture 2010, shown in FIG. 5, end terminals 2064 are incumbent devices that do not support switched digital video (SDV) format. In one example, end terminals 2044 are analog devices, such as CRT television sets. Incumbent end terminals 2064 are set top boxes manufactured by Vendor M, and only support program content streams encrypted with Vendor M's proprietary conditional access encryption protocol (e.g., CAS 1). In other words, the conditional access decrypter 1052 (FIG. 3) within the set top box is paired with the first encryptor 2066. The incumbent devices 2064 do not include up-to-date application software and/or hardware that support SDV content. In the illustrated embodiment, second CAS end terminals 2078 are upgraded devices manufactured by Vendor C and support SDV content. However, Vendor C's set top boxes 2078 cannot decrypt the content from the first channel service offering 2062 because Vendor C's conditional access decrypter 1052 is not paired with Vendor M's proprietary encryptor 2066. However, Vendor C's set top boxes 2078 comprise a conditional access decrypter (e.g., 2080 in FIG. 4) that is configured to decode a second, SDV channel service offering encrypted by a separate encryption protocol.

In accordance with one embodiment of the present invention, the telecommunications system 2010 includes a second conditional access system 2070 (CAS 2) coupled to the broadcast content source 2020 to deliver a second channel service offering 2072 over the access network 2014. In one embodiment, the second conditional access system 2070 is a switched digital system. The second conditional access system 2070 includes a second encryptor 2074 adapted to encrypt at least a portion of the second channel service offering 2072 according to a second conditional access protocol. The second conditional access system 2070 further includes a content manager 2098 which, in the illustrated embodiment, is a Cisco D-9900 Digital Content Manager manufactured by Cisco Systems, Inc., of San Jose, Calif. The content manager 2098 functions in much the same manner as the incumbent content manager 2088, except the output (e.g., second channel service offering 2072) is in single program transport stream (SPTS) format.

Although not illustrated, in another embodiment of the invention the content manager 2088 for the first conditional access system 2060 can be integrated with the content manager 2098 for the second conditional access system 2070. This embodiment is shown schematically in FIG. 5 by a dashed line joining the two content managers.

An edge modulation device 2076 modulates the second channel service offering 2072 onto the access network 2014 for delivery to second CAS end terminals 2078. In one example, the edge modulation device 2076 is an edge QAM. The second CAS end terminals 2078 are provisioned with a second CAS decrypter 2080 to decrypt the second channel service offering 2072.

A network control system 2100 provides for the management, monitoring, and control of network elements and delivery services provided to subscriber locations, including management and control of second CAS end terminals 2078. Typical functions of the network control system 2100 include processing and managing digital broadcast service definitions, assigning network 2010 resources for transporting digital broadcast services, communicating system information to the subscribers, and informing the conditional access system of the security requirements of digital video services. The network control system 2100 also allocates network resources for digital video services, including SDV services. Requests for resources come to the network control system 2100 from the broadcast content sources 2020 via session a universal session and resource manager (USRM) 2102. Upon receipt of a resource request, the network control system 2100 will allocate the appropriate network resources and store this allocation within its database system. The network control system 2100 controls the second channel service offerings 2072 through a network router or network switch 2104, such as the Catalyst 4948 switch manufactured by Cisco Systems, Inc.

In one embodiment of the invention, the second channel service offering 2072 comprises the first channel service offering 2062 plus additional content. However, in contrast to the first channel service offering 2062 that is broadcast up to the set top box at the subscriber location at all times, the channel content in the second stream 2072 passes through the network 2010 only when requested by one or more subscribers. Upon request, the particular channel is switched onto the network. This switched digital video system alleviates the “dormant bandwidth” problem associated with traditional cable content delivery. Also, unlike video on-demand (VoD), which switches a unicast interactive program to a user, switched digital video switches multicast streams, making each stream available to one or more subscribers who simply join the stream just as they would with normal broadcast services. That is, once a switched service is streamed to a subscriber, subsequent subscribers associated with the same service group as the first subscriber can tune to the same broadcast stream.

In one possible implementation, the second channel service offering 2072 from the content manager 2098 is connected to the network switch 2104 and SDV sessions are coordinated by a universal session and resource manager (USRM) 2102, such as a Cisco D9510 Universal Session and Resource Manager. The USRM 2102 can be managed by the network control system 2100. The subscriber can set up an SDV session with the session manager 2102 when an SDV program is requested via the interactive program guide, for example. The session manager 2102 will determine if the requested channel is already being sent to the corresponding service group that the subscriber belongs to. The subscriber will be assigned to join the existing SDV session if the requested channel is available at the service group or assigned to a new SDV session if the requested channel is not available at the service group. The session manager 2102 will negotiate with edge modulation devices 2076 to allocate resources required for the session.

The edge modulation device 2076 can be a digital modulator, such as GQAM modulator Model D9479 manufactured by Cisco Systems. The number of edge devices 2076 in each service group may vary as needs dictate. The edge device 2076 dynamically retrieves the MPEG single program channel service offering that carries the requested broadcast program (typically via IP unicast or multicast) and generates the MPEG multiple program channel service offering. Typically, a single QAM modulator can compress ten to twelve modulated SD programs in MPEG-2 format, although the actual number will be dictated by a number of factors, including the communication standard that is employed. In the illustrated example, the edge QAM modulators 2076 are adapted to receive Ethernet frames that encapsulate the transport packets (e.g. second channel service offering 2072), de-capsulate these frames, and transmit radio frequency signals representative of the channel service offering packets to end users, over the HFC network 2014. Each channel service offering is mapped to a downstream QAM channel. Each QAM channel has a carrier frequency that differs from the carrier frequency of the other channels. The channel service offerings are mapped according to the program map table (PMT) designed by the MSO that operates the network. An edge resource manager, such as the USRM 2102, allocates and manages the resources of the edge devices 2076. The edge resource manager communicates with and receives instructions from the session manager which is integrated with the USRM.

In one embodiment of the invention, the carrier frequency of each edge QAM channel carrying the SDV second channel service offering 2072 is different from any carrier frequency used for the EIA transport channels assigned to the 256-QAM SDTV/HDTV broadcast tier (e.g., first channel service offering 2062). For example, the edge QAM modulators 2076 can modulate the SDV content onto a series of 6 MHz-wide EIA transport channels in an RF range between 54 MHz and 870 MHz. In this manner, the combined transport stream 2096 can include both first channel service offering 2062 and second channel service offering 2072, modulated onto different RF carrier frequencies.

FIG. 7 depicts one possible implementation of a spectrum 2024 of RF transport channels. The spectrum 2024 includes an analog tier 2026 comprising 40 to 90 transport channels. One analog program channel may be transmitted on each transport channel of the analog tier 2026. The spectrum 2024 further includes an SD/HD tier 2028 comprising digital program channels formatted in standard definition (SD) and high definition (HD). The SD/HD tier 2028 may comprise 40 to 50 transport channels, with each channel capable of carrying approximately 7-12 SD program channels in MPEG2 format, 2-3 HD program channels in MPEG2 format, or some combination of both. The spectrum 2024 may further include a small block of digital telephone transport channels 2030 for carrying voice over Internet protocol (VoIP) transmissions, for example. The spectrum 2024 may further include a block of channels 2032 reserved for Internet traffic. The number of transport channels assigned to each tier 2026, 2028 or block 2030, 2032 depends on the particular needs of the cable operator. In any event, there typically exist a number of spare transport channels 2106 that can be used to deploy the SDV programming content in the second channel service offering 2072. Of particular note with reference to FIG. 7 is that the depicted RF spectrum for the second channel service offering 2072 is not limited to the depicted spectrum of the spare transport channels 2106. The second channel service offering 2072 may occupy non-contiguous EIA slots anywhere in the RF range (e.g., 54-870 MHz).

As noted, the entire video line-up offered by the incumbent cable provider can be made available to a subscriber, but would only be switched onto the network when requested by the subscriber. Thus, the entire video line-up occupied by the first channel service offering 2062 (e.g., 2028) and encrypted according to the first CAS protocol can also be simulcast over the second channel service offering 2072 and encrypted according to the second CAS protocol. However, the number of transport channels required to broadcast the entire video line-up using the second channel service offering 2072 is much smaller. The bandwidth or frequency range required to deploy the content of the first channel service offering 2062 is thus broader than the frequency range required to deploy the content of the second channel service offering 2072, even though the content (e.g., potential number of program channels available to watch) of the second channel service offering 2072 can be far greater than that of the first channel service offering 2062.

Returning to FIG. 5, the telecommunications system 2010 may further include a virtual local area network (VLAN) 2108 between the network switch 2104 and the edge devices 2076 to logically segment and transmit the transport packets in the switched digital video channel service offering 2072. Similarly, the network 2010 may further include a control VLAN 2110 to logically segment and transmit control instructions from the network control system 2100 to the edge devices 2076 and to QPSK modulator 2112. The QPSK modulator 2112 works in conjunction with the second CAS digital set top boxes 2078 and a QPSK demodulator 2114 to provide forward signaling and reverse path communications for interactive video and data systems over the two-way CATV telecommunications system 2010. As illustrated, a plurality of QPSK demodulators 2114 interface with the QPSK modulator 2112 through ATM25 interfaces.

The SDV channel service offering 2072 is encrypted using a second encryptor 2074 that employs a different encryption method, such as bulk encrypting, wherein a large number of input streams are encrypted at once, after they have been aggregated. In one example, the second encryptor 2074 is a Netcrypt™ Bulk Encryptor manufactured by Cisco Systems. The Netcrypt Bulk Encryptor 2074 can be connected to the network switch 2104 using Four Gigabit Ethernet ports in bi-directional mode. The QAM modulator edge devices 2076 can be connected to ports on the Gigabit Ethernet switch 2104 either directly or remotely through network transport equipment such the video VLAN 2108. The Netcrypt Bulk Encryptor receives the digital portion of the second channel service offering 2072 and encrypts the required content, then sends the video to the edge device's Gigabit Ethernet switch for distribution through the telecommunications system 2010. As noted, the encrypted SDV channel service offering 2072 is modulated onto the combined transport stream 2096. In some embodiments, the bulk encryptor 2074 can be integrated with the edge device 2076 to form an encryptor/modulator. In any event, upon arrival at the set top box(es) that requested the SDV content, e.g., boxes 2078, Vendor C's conditional access decrypter 1052 decodes the program stream and transmits it to the display 1046, for example.

Even if the SDV channel service offering 2072 supports transmission of the entire line-up of the 256-QAM SDTV/HDTV broadcast tier (not just long-tail programming), the actual bandwidth used by the SDV channel service offering 2072 will be a small fraction of that used by the first channel service offering 2062. This is because the SDV channel service offering 2072 only includes programs actually being requested within a service group, as compared to all program content being pushed to a subscriber's set top box, as is the case with the first channel service offering 2062. The actual number of EIA channels required to simulcast the entire SDTV/HDTV broadcast tier is dependent upon several factors such as service group size, content popularity and viewership, the format of the video (e.g., MPEG-2 or MPEG-4), and the total number of video program streams, for example. Nevertheless, the amount of spectrum required for SDV is significantly less than for the incumbent broadcast. Therefore, using only the SDV tier of QAM channels, the disclosed telecommunications system 2010 permits the cable operator to make available to the subscriber the incumbent program lineup plus much more additional content, which may be additional high definition channels obtained from the program input streams 2022b. In fact, the inventors do not foresee an upper limit on the number of HD channels that can be supported by the SDV channel service offering 2072. This is because the upper limit of the channel service offering is predicated on the maximum number of programs being watched (or recorded) in a service group. As long as bandwidth is available to support a program being watched on all the end terminals in a service group, there are almost a limitless number of programs that can be offered for viewing. This is in contrast to the traditional method of program content delivery, in which the upper limit of the channel service offering is predicated on the number of programs that can be compressed onto the RF spectrum and delivered to all end terminals in the service group, whether the customer is requesting them or not.

The service group sizes and dedicated QAM slots can be managed by the operator if bandwidth becomes limited. For example, the size of the service group can be reduced, or the number of dedicated edge QAM slots in the SDV tier can be increased. In this manner, the operator maintains the flexibility to satisfy the needs of all customers.

The disclosed telecommunications system 2010 benefits the cable operator because this additional program content can be implemented without scrapping out the existing incumbent system. The disclosed SDV system operates independently with its own encryption, QAMs, and set top boxes. The transition from incumbent STBs to the SDV STBs can be made at the discretion of the cable operator and, even better, at the discretion of the paying customer. Offering a broader set of services (e.g., access to 200 HD channels) results in customer willingness to pay more, even though the operator is not using more bandwidth.

One potential drawback to the telecommunications system 2010 disclosed in FIG. 5 is the high capital cost of the equipment required to host and manage SDV sessions, making the venture cost-prohibitive for all but the largest MSOs. The inventors of the present invention have developed a cost-effective architecture and method of operation that permits even the smallest cable operators to affordably utilize SDV session management and offer a greater choice of program content for their subscribers.

Turning now to FIG. 6, wherein like numerals indicate like elements in FIGS. 1-5, a broadband telecommunications system 3010 includes a hosted portion 3116 that manages the switched digital video channel service offering 2072. In one embodiment, the hosted portion 3116 includes many of the subsystems and functions normally located within the service infrastructure. In one embodiment, the hosted portion 3116 includes a network control system 3100, which may comprise a Sun workstation. Because the network control system 3100 resides in a hosted environment, it is not limited to hosting a single cable operator. Rather, the network control system 3100 can manage, monitor, and control network elements and video delivery services from a plurality of cable operators.

The hosted portion 3116 may further include application servers to provide for conditional access authority, session-based encryption, interactive set top box applications, for example.

In one embodiment, the hosted portion 3116 includes application servers hosting a digital services platform 3118, such as the OpenStream® Digital Services Platform (DSP) by Ericsson. The digital services platform 3118 enables deployment of video on-demand (VOD) services, and can also provide an infrastructure for advanced digital services beyond VOD. For example, the digital services platform 3118 can provide a real-time billing system interface for a billing system residing on the service infrastructure 2018. The DSP 3118 can also provide asset and content management for the telecommunications system 3010. Further, the DSP 3118 can maintain a database of assets that are loaded into the system for use by applications and other components, and create a catalog for customers. The DSP 3118 may further include a propagation director component to manage content and enable content routing based on metadata rules, enabling better management of content stores. The DSP 3118 may further include an integrated session and services gateway to provide centralized set-up and tear down for all sessions, messaging and interfaces to VOD, and other digital services applications. The session resource manager can also interface with a network policy manager for bandwidth negotiation. The DSP 3118 may further include a catalog gateway, which is an interface that allows third-party web portals and recommendation engines to access the service provider's catalog. Catalog gateway expands the discovery and selection of relevant offerings available to the subscriber.

Service infrastructure subsystems and functions not handled by the hosted portion 3116 of the telecommunications system 3010 may be located in the headend. For example, the service infrastructure 2018 may include application servers and server applications, and an administrative gateway (AG) for providing subscriber and service provisioning and authorization information to the network 3010 for use in controlling access to the network and its services. The AG may also be responsible for providing content source provisioning information to the network for use in establishing communications with broadcast content source systems. The AG may be embodied within the billing system, or may be an interface between a billing system and the network. The service infrastructure 2018 may further include a network management system to maintain a database of system status and performance information to provide fault isolation and recovery capabilities.

In the illustrated embodiment, the hosted portion 3116 communicates with the network switch 2104 by way of a router 3120, such as a Cisco 2911 Integrated Services Router. The router 3120 can provide the flexibility to manage the array of services performed by the hosted portion 3116, and can further provide cloud extensibility and services “on-demand” that decouples hardware and software so that virtual services can be remotely deployed and managed. Security for the hosted communication path 3122 may be provided by a site-to-site virtual private network (VPN) 3124, for example. The site-to-site VPN 3124 allows encrypted inter-connection between the headend components (such as network switch 2104) and the hosted portion network.

As can be appreciated, the hosted portion 3116 can provide a variety of service infrastructure functions related to the delivery of the SDV channel service offering 2072, thereby relieving the MSO of the burden. One advantage of the hosted portion 3116 is that a cable operator does not have to buy all the platform equipment and services required to initiate SDV sessions. Instead, the cable operator can lease the equipment and services, for example, from a third-party operator of the hosted portion 3116. This business model fractionalizes the capital and operational expenditures for the cable operator, as compared to buying outright. Similarly, the third-party operator of the hosted portion 3116 may spread the capital and operational expenditures over tens, if not hundreds, of small- to medium-sized cable operators.

In one example, the hosted portion 3116 operates from a cloud computing environment. Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least five deployment models.

The first characteristic may be described as on-demand self-service, wherein a cloud consumer can unilaterally provision computing capabilities, such as server time and network storage, as needed automatically without requiring human interaction with the service's provider. The second characteristic may be described as broad network access, wherein capabilities are available over a network and accessed through standard mechanisms that promote use by heterogeneous thin or thick client platforms (e.g., mobile phones, laptops, and PDAs). The third characteristic may be described as resource pooling, wherein the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). In one embodiment of the invention, the hosted portion 3116 in the cloud computing environment has the characteristic of resource pooling. The fourth characteristic may be described as rapid elasticity, wherein capabilities can be rapidly and elastically provisioned, in some cases automatically, to quickly scale out and rapidly released to quickly scale in. To the MSO, the capabilities available for provisioning often appear to be unlimited and can be purchased in any quantity at any time. The fifth characteristic may be described as measured service, wherein cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and MSO.

The first service model in a cloud computing environment is Software as a Service (SaaS), wherein the capability provided to the consumer is to use the provider's applications running on a cloud infrastructure. The applications are accessible from various client devices through a thin client interface such as a web browser. The consumer does not manage or control the underlying cloud infrastructure including network, servers, operating systems, storage, or even individual application capabilities, with the possible exception of limited user-specific application configuration settings.

The second service model is Platform as a Service (PaaS), wherein the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

The third service model is Infrastructure as a Service (IaaS), wherein the capability provided to the consumer (MSO) is to provision processing, storage, networks, and other fundamental computing resources where the consumer is able to deploy and run arbitrary software, which can include operating systems and applications. The MSO does not manage or control the underlying cloud infrastructure but has control over operating systems, storage, deployed applications, and possibly limited control of select networking components. In one embodiment of the invention, the hosted portion 3116 in the cloud computing environment utilizes the IaaS service model.

The first deployment model is the private cloud, wherein the cloud infrastructure is operated solely for an organization. It may be managed by the organization or a third party and may exist on-premises or off-premises. The second deployment model is a community cloud, wherein the cloud infrastructure is shared by several organizations and supports a specific community that has shared concerns (e.g., mission, security requirements, policy, and compliance considerations). It may be managed by the organizations or a third party and may exist on-premises or off-premises. In one embodiment of the present invention, the hosted portion 3116 in the cloud computing environment is deployed in a community cloud. The third deployment model is a public cloud, wherein the cloud infrastructure is made available to the general public or a large industry group and is owned by an organization selling cloud services. The fourth deployment model is a hybrid cloud, wherein the cloud infrastructure is a composition of two or more clouds (e.g., private, community, or public) that remain unique entities but are bound together by standardized or proprietary technology that enables data and application portability (e.g., cloud bursting for load balancing between clouds). The fifth and last deployment model is private cloud rentals, wherein a cloud computing environment is service oriented with a focus on statelessness, low coupling, modularity, and semantic interoperability.

At the heart of cloud computing is an infrastructure comprising a network of interconnected nodes. Still with reference to FIG. 6, the illustrative cloud computing environment 3116 includes one or more cloud computing nodes 3126 with which headend devices (e.g., network switch 2104) may communicate. Nodes 3126 may communicate with one another. Although not shown, they may be grouped physically or virtually, in one or more networks, such as Private, Community, Public, Hybrid, or Rental clouds as described hereinabove, or a combination thereof. This allows cloud computing environment 3116 to offer infrastructure, platforms and/or software as services for which an MSO does not need to maintain resources on their network. It is understood that the types of headend devices shown in FIG. 6 are intended to be illustrative only and that computing nodes 3126 and cloud computing environment 3116 can communicate with any type of computerized device over any type of network and/or network addressable connection (e.g., using a web browser).

The cloud computing environment 3116 provides hardware and software components. It should be understood in advance that the components and functions shown in FIG. 6 are intended to be illustrative only and embodiments of the invention are not limited thereto. Examples of hardware components include mainframes, servers, Reduced Instruction Set Computer architecture based (RISC) servers, storage devices, networks, and networking components. Examples of software components include network application server software, application server software, and database software.

The cloud computing environment 3116 may further provide virtual entities such as virtual servers, virtual storage, virtual networks, including virtual private networks, virtual applications and operating systems, and virtual clients.

In addition, the cloud computing environment 3116 may provide management functions such as resource provisioning for dynamic procurement of computing resources and other resources that are utilized to perform tasks within the cloud computing environment. Management functions may include metering and pricing to provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. A user portal such as VPN 3124 provides access to the cloud computing environment for each of the MSOs. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

The cloud computing environment 3116 provides functionality for which the cloud computing environment may be utilized. As noted, functions which may be provided include real-time billing system interface, asset and content management, integrated session and services gateway, and bandwidth negotiation.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A telecommunications system adapted to simulcast video content over a radio frequency spectrum to a customer network of end terminals, the system comprising:
a broadcast content source providing program input streams;
a first encryptor coupled to the broadcast content source, adapted to encrypt at least a portion of a first channel service offering according to a first conditional access protocol;
a second encryptor coupled to the broadcast content source, adapted to encrypt at least a portion of a second channel service offering according to a second conditional access protocol, the second channel service offering comprising the first channel service offering plus additional video content;
a network switch adapted to route, upon a request from an end terminal, a portion of the second channel service offering to the end terminal, the end terminal being adapted to decrypt the portion of the second channel service offering; and
an access layer network combiner device adapted to combine the first channel service offering and the second channel service offering onto a single combined channel service offering for simulcast to the customer network, thereby permitting the customer network end terminals to decrypt as desired from the first conditional access protocol or the second conditional access protocol.

2. The telecommunications system of claim 1, wherein the first channel service offering is modulated over a first plurality of transport channels in a first frequency range of the radio frequency spectrum, and the second channel service offering is modulated over a second plurality of transport channels in a second frequency range of the radio frequency spectrum.

3. The telecommunications system of claim 2, wherein the first plurality of transport channels in the first frequency range is greater than the second plurality of transport channels in the second frequency range.

4. The telecommunications system of claim 2, wherein the first frequency range is broader than the second frequency range.

5. The telecommunications system of claim 1, further comprising a content manager adapted to aggregate the program input streams onto the second channel service offering.

6. The telecommunications system of claim 5, wherein an output format of the content manager is single program transport stream.

7. The telecommunications system of claim 1, wherein at least a portion of the second channel service offering comprises a switched digital video stream.

8. The telecommunications system of claim 7, wherein the second channel service offering comprises a switched digital version of an analog format program stream.

9. The telecommunications system of claim 7, wherein the second encryptor is a bulk encryptor.

10. The telecommunications system of claim 9, wherein the second encryptor is an encryptor/modulator.

11. The telecommunications system of claim 1, wherein a format of the second channel service offering comprises IPTV over DOCSIS.

12. The telecommunications system of claim 11, wherein the second encryptor comprises digital rights management.

13. The telecommunications system of claim 1, further comprising an RF modulator adapted to modulate the second channel service offering over the radio frequency spectrum.

14. The telecommunications system of claim 13, wherein the RF modulator is an edge QAM modulator.

15. The telecommunications system of claim 1, wherein the additional video content of the second channel service offering comprises additional high definition channels.

16. The telecommunications system of claim 1, wherein the second channel service offering additionally comprises value-added program streams.

17. A method for simulcasting video content to a customer network of end terminals, comprising the steps of:
aggregating a program input stream from a broadcast content source onto a first channel service offering and a second channel service offering, the first channel service offering comprising a first channel lineup, the second channel service offering comprising a second channel lineup, the second channel lineup including at least the first channel lineup;
encrypting at least a portion of the first channel service offering with a first encryptor, the first encryptor adapted to encrypt a video content stream according to a first conditional access protocol;
encrypting at least a portion of the second channel service offering with a second encryptor, the second encryptor adapted to encrypt a video content stream according to a second conditional access protocol;
switching a program stream onto the second channel service offering, the switching step in response to one or more of the end terminals selecting a program channel from the second channel lineup; and
combining the first channel service offering and the second channel service offering onto a combined channel service offering for simulcast to the customer network of end terminals.

18. The method of claim 17, wherein the switching step is managed from a network control system located in a hosted portion of the telecommunications system.

19. The method of claim 18, wherein the hosted portion is a cloud computing environment.

20. The method of claim 17, further comprising the step of decrypting, by the customer network of end terminals, the first channel service offering according to the first conditional access protocol or the second channel service offering according to the second conditional access protocol.

21. The method of claim 17, further comprising a step of modulating the first channel service offering over a first plurality of transport channels in a first frequency range of a radio frequency spectrum, and modulating the second channel service offering over a second plurality of transport channels in a second frequency range of the radio frequency spectrum.

22. The method of claim 21, wherein the first plurality of transport channels in the first frequency range is greater than the second plurality of transport channels in the second frequency range.

23. The method of claim 21, wherein the first frequency range is broader than the second frequency range.
